(19) United States
(12) Patent Application Publication
(10) Pub. No.: US 2015/0288407 A1
(43) Pub. Date: Oct. 8, 2015

(54) Phone Wrist Mount

(71) Applicant: Joel Hernandez, Miami, FL (US)

(72) Inventor: Joel Hernandez, Miami, FL (US)

(21) Appl. No.: 14/677,922

(22) Filed: Apr. 2, 2015

Related U.S. Application Data
(60) Provisional application No. 61/974,089, filed on Apr. 2, 2014.

(51) Int. Cl. H04B 1/3888; A45F 5/00

(52) U.S. Cl. CPC H04B 1/3888; A45F 5/00; A45F 2005/008; A45F 2200/0516

(57) ABSTRACT

A wrist mount for attaching a portable electronic device to the wrist or forearm of a person. A band attaches over a forearm or wrist and includes a socket on its exterior. A plate on one side attaches to the portable electronic device and on a second side has a neck that engages into the socket. The neck and socket result in a rotatable joint that may be indexed and biased at a predetermined angle of the band relative to the plate. In one version micro suction cups on the first side of the plate secure the electronic device to the plate.

### BACKGROUND OF THE INVENTION

1. Field of the Invention.

The present invention relates to wearable electronic devices, and more particularly, to a device to attach a phone or other small electronic device to a human forearm or wrist.

2. Other Related Applications.

The present application claims benefit to pending U.S. provisional patent application 61/974,089 filed on 2 Apr. 2014, which is hereby incorporated in its entirety by reference.

3. Description of the Related Art.

Several designs for wearable electronics have been designed in the past. None of them, however, includes a comfortable wrist or forearm worn device that securely attaches to a mobile phone or other portable electronic device that allows convenient rotation of the phone to portrait or landscape orientation and the phone is separable from the wrist band portion.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a comfortable device to secure a mobile electronic device to an arm of a user.

It is another object of this invention to provide a device to safely carry a mobile phone or other similar device in a portrait or landscape orientation.

It is still another object of the present invention to provide a wrist mount for a portable electronic device that quickly and easily attaches and detaches from the wrist of the user.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 shows a perspective view of a phone wrist mount separated from an electronic device.

FIG. 2 shows a perspective view of a variation of a phone wrist mount.

FIG. 3 shows a perspective view of an alternate version of a phone wrist mount.

FIG. 4 shows a plan view of a phone wrist mount in a landscape orientation mode and another in a portrait orientation mode.

FIG. 5 shows a perspective view of a variant of a phone wrist mount with an inset detail demonstrating an example of an attachment means.

FIG. 6 shows a perspective view of another embodiment of a phone wrist mount.

### DETAILED DESCRIPTION OF THE PREFERRED EMBODIMENT

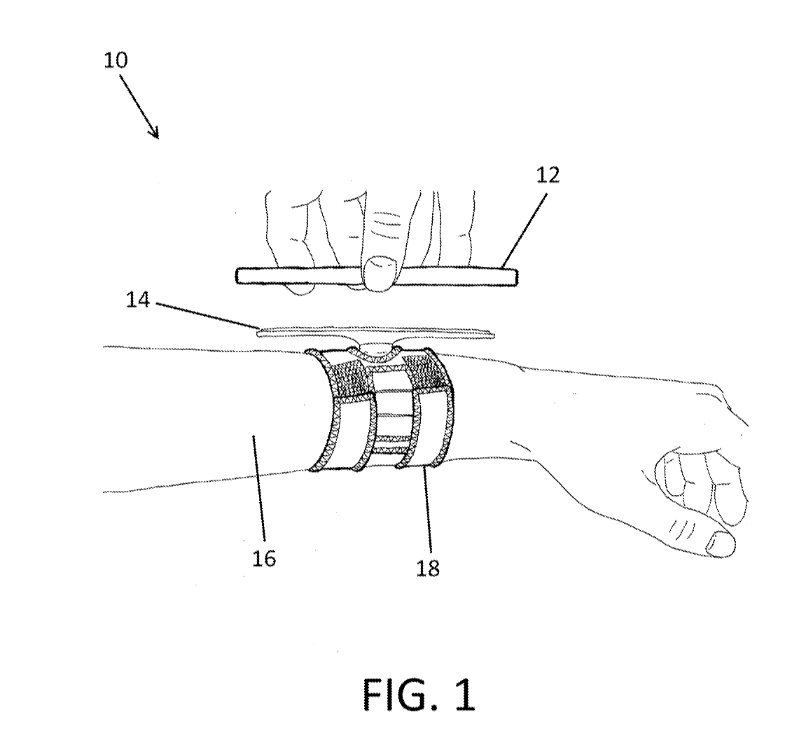

Referring now to the drawings, where the present invention is generally referred to in FIG. 1 with numeral 10, it can be observed that it basically includes, among other features, an electronic device 12, a plate 14, a forearm 16 and a band 18.

It should be appreciated that the term forearm 16 can be used interchangeably with the term wrist. The device, in any of its embodiments, is generally worn somewhere on or between a wearer's forearm and wrist. In some applications the device may also be attached to other objects, for example a bicycle's handle bars, or other similarly shaped object as determined by the user.

Generally, the band 18 is secured around a forearm 16 of a user of the device. The band 18 is adapted to readily attach and detach from the wearer's forearm 16.

A plate 14 is affixed to the band 18. During use of the device an electronic device 12 is affixed to the plate 14 (or other analogous part in other versions of the device). The plate 14 in at least one version of the device is rigid and dimensioned to be about the same size as a mobile phone or slightly larger or smaller than a contemplated electronic device 12.

It should be understood that the example of an electronic device 12 is shown to be a modern mobile or cellular phone but can be any portable electronic device. For example, the invention has been shown to be effective for global positioning system (GPS) devices, audio players, video players or other suitable electronic device.

Yet referring to FIG. 1, this drawing shows the electronic device 12 in the process of attachment to the plate 14. As the electronic device 12 is brought into contact with the plate 14 the two are temporarily connected and are ready for use. Typically this is a one hand operation because the forearm wearing the device is often not well positioned to contribute to the efforts of attaching or removing the electronic device 12 from the balance of the invention.

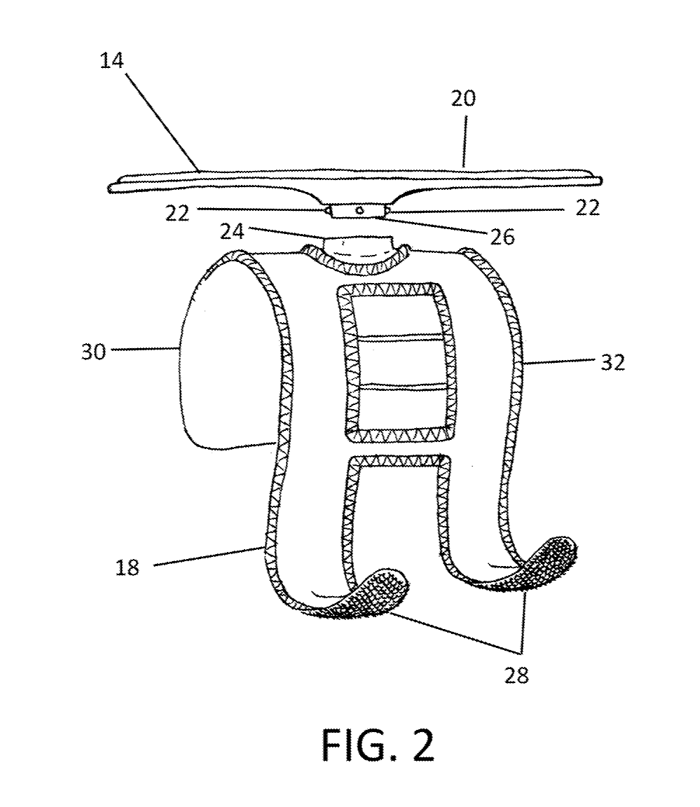

FIG. 2 shows an iteration of the invention including, among other features, a plate 14, a band 18, a surface 20, multiple tabs 22, a socket 24, a neck 26, a fastener 28, a surface 30 and trim 32. In this figure the plate 14 is slightly separated from the balance of the device to better illustrate the interaction between the several elements. An electronic device is not shown in FIG. 2 and would mate with and be affixed to the plate 14 along the surface 20.

To affix this style of device onto a wrist the band 18 is wrapped around the wrist snugly and the ends of the band 18 having the integrated fastener 28 are connected to surface 30. The fastener 28 and surface 30 may be complementary hook and loop configuration, an adhesive combination, magnets, clips, buckles or any other available means to operatively permit application and removal of the device from the arm of the wearer without undue complication.

Optionally, edging trim 32 may decorate the various parts of the band 18. The trim 32 is functional in that it could provide further structure and strengthening the edges of the band 18. It may be a contrasting or complementary color.

The band 18 is preferably constructed of a pliable and durable material. For example, fabric, leather or plastic could be effective. For some applications a breathable material can improve comfort, such as during athletic use.

The plate 14 is affixed to the band 18 at a socket 24 on the band. In this version of the device the socket 24 is cylindrical and includes an annular ring on its interior. The reverse of the plate 14 has a neck 26 dimensioned to fit inside the socket 24. When the neck 26 is fully seated into the socket 24 the spring tabs 22 lock into the annular ring inside the socket 24 to keep the neck 26 into the socket.

The cylindrical neck 26 fits into the cylindrical socket 24 so that the plate 14 is permitted to rotate relative to the band 18 yet remain connected to the band 18. The annular ring inside the socket may be indexed so that when the neck 26 is rotated inside the socket 26 the tabs 22 snap into the index indentations to bias the rotation to hold at the indexed position. For example, with four tabs 22 on the neck 26 each at ninety degree increments matching with four index indentations inside the socket 24, also at ninety degrees, the rotation of the plate 14 can be biased to four positions at ninety degree intervals. In this way the electronic device affixed to the plate 14 can be held at either portrait orientation or landscape orientation, each right side up or up side down.

The surface 20 of the plate 14 contacts and secures the electronic device to the invention. Surface 20 preferably has a means to temporarily join, for example a phone, to the plate 14. Surface 20 may be covered with hundreds or thousands of micro-suction cups that grab a phone. Other highly supple rubber or plastic materials can grab and hold the phone. Some adhesives may be suitable. Optionally clips, a strap or tether can provide further protection from the electronic device inadvertently separating from the plate 14.

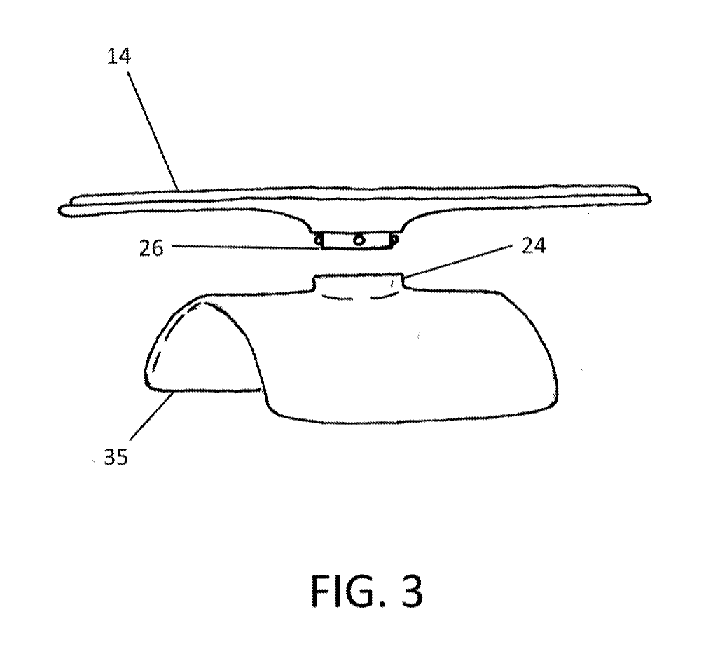

Now referring to FIG. 3 where a sub-structure is shown to include a support 35 with an integral socket 24. As in earlier described versions the plate 14 at the neck 26 is inserted into the socket to connect the plate 14 to a band. The support 35 may be integrated into the design, for example, of the device shown in FIG. 2 to provide improved structure of the device as a whole.

The support 35 may optionally be fabricated of a rigid material, such as plastic or metal. The support 35 can be semi-tubular to fit well onto a human forearm or wrist. The support 35 could be plastic molded complete with an integral socket 24. The support 35 can be held against the forearm or wrist under a band similar to the band 18 in FIG. 2.

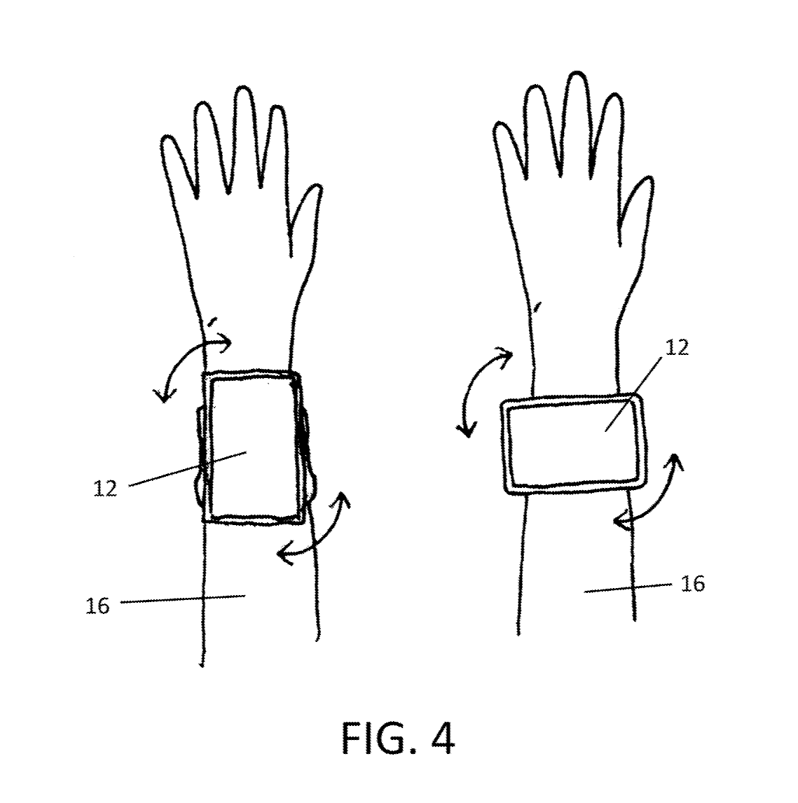

FIG. 4 shows on the left the landscape orientation of an electronic device 12 on a forearm 16. On the right is a portrait orientation of an electronic device 12. In a preferred version of the device the rotation of the device is biased to selectively hold the orientation of the electronic device at either a landscape or portrait orientation depending on the user's preference for a give use of the electronic device.

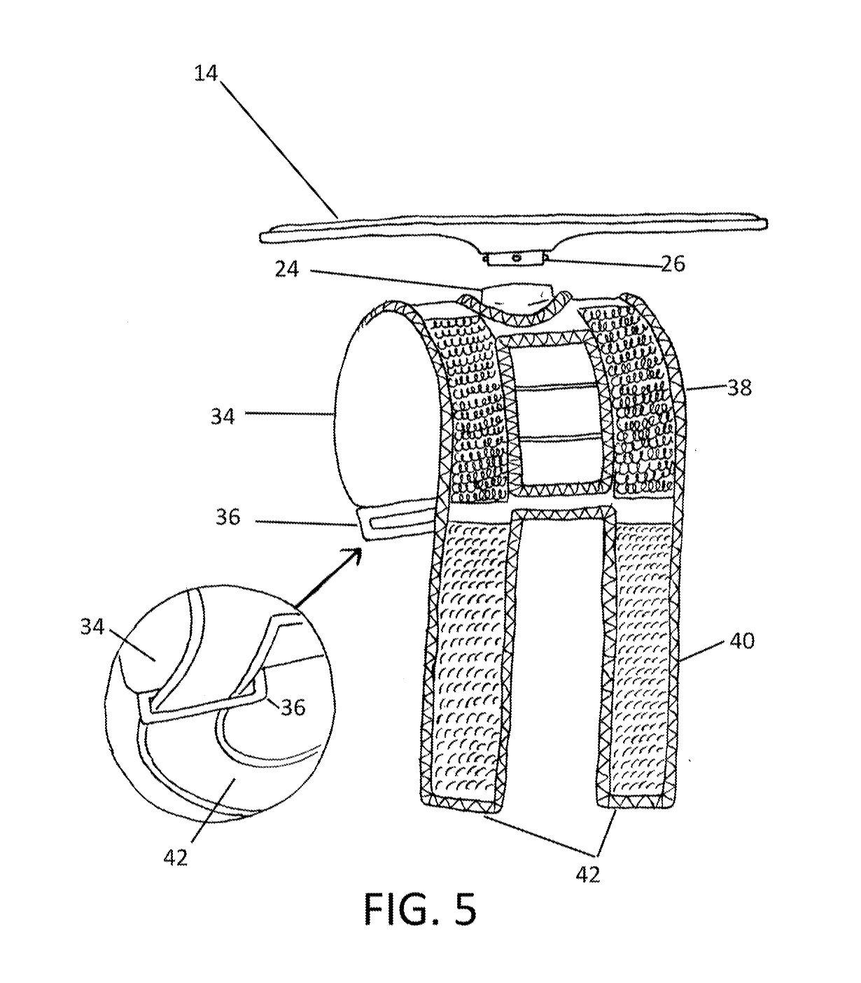

FIG. 5 shows another variant of a wrist mount device that includes, among other features, a plate 14, a socket 24, a neck 26, a band 34, a buckle 36, a surface 38, a surface 40 and straps 42.

FIG. 5 demonstrates, among other features, an alternate band 34 construction. To install the device onto the wrist or forearm the wearer would place the band 34 over the top of the wrist. A strap 42 is then fed through the buckle 36 where it is cinched double back. The surface 40 is then mated with surface 38 where surface 40 is joined to surface 38 in removable fashion.

Surface 38 and surface 40 can be made of complementary parts of a hook and look fastener, adhesive, magnets, additional buckles or other convenient means to secure the band 34 about a human arm, forearm or wrist.

FIG. 5 shows two straps 42 on an end of the band 34. Each strap 42 could have its own buckle 36 adjacent to the buckle 36 as depicted. A support similar to the support 35 shown in FIG. 3 could also be used effectively with the device shown in FIG. 5.

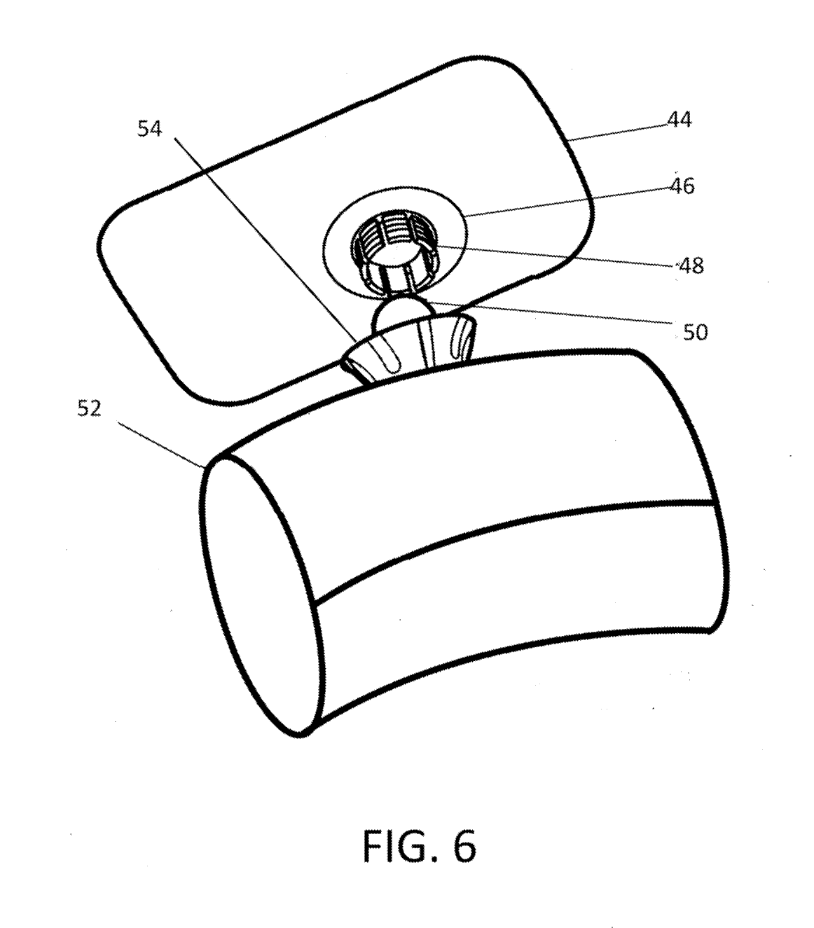

FIG. 6 illustrates another type of wrist mount for an electronic device comprised of, among other features, a plate 44, a backing 46, a ring 48, a ball 50, a band 52 and a collar 54.

The plate 44 functions similar to the plates described above as used in other versions. The bottom side of the plate 44 in this version has a threaded ring 48 affixed to the bottom of the plate 44 at a backing 46. The inside of the ring is dimensioned to accept the ball 50 that is in turn affixed to the band 52. The interior of the collar 54 is threaded to mate with the external threads on the ring 48.

When the collar 54 is fully seated over the ring 48 the ball 50 is squeezed inside the ring 48 thus preventing the plate 44 from moving relative to the band 52. If the collar 54 is loosened somewhat then the ball 50 is freed to rotate inside the ring 48. In this way the orientation of the plate 44 can be infinitely adjusted to any angle that the user finds convenient.

The device can be fairly described as a phone wrist mount comprised of a band and a plate. The band is dimensioned to removably fit onto a human forearm or wrist. The band includes a socket that is exposed on an exterior side of the band. The plate has a first surface and a second surface joined by a perimeter edge. The plate is generally rigid. The first surface of the plate is covered with an adherent such as micro suction cups to stick the phone to the plate yet allow it to be removable. The second surface of the plate includes a neck. The neck is dimensioned to engage with the socket at rotate about an imaginary axis shared by the neck and socket when engaged. The neck engages into the socket forming a rotatable joint. The plate rotates relative to band about the rotatable joint. The rotatable joint is indexed to bias the plate relative to the band at a predetermined angle.

Other versions may or may not include that the adherent is any of a plurality (hundreds or thousands) of micro suction cups, a sticky adhesive layer or a supple layer that grabs the hard case of a phone without an adhesive. In any version an option includes that the rotatable joint is indexed to orient a phone attached to the second surface of the plate at a portrait orientation or a landscape orientation. Another option includes that the strap is securable to a user's forearm or wrist with hook and look fasteners.

Another version of the device can be fairly described as a phone wrist mount comprised of a band and a plate. The band is dimensioned to removably fit onto a human forearm or wrist. The band includes a socket that is exposed on an exterior side of the band. The plate has a first surface and a second surface joined by a perimeter edge. The first surface of the plate is covered with a plurality of micro suction cups. The second surface of the plate includes a neck. The neck is dimensioned to engage with the socket. The neck engages into the socket forming a rotatable joint. The plate rotates relative to band about the rotatable joint. The rotatable joint is indexed to bias the plate relative to the band at a predetermined angle. The rotatable joint is indexed to orient a phone attached to the second surface of the plate at a portrait orientation or a landscape orientation. the strap is securable to a user's forearm or wrist with hook and look fasteners.

It should be noted that any of the features in any of the several variations of the design could be implemented together and remain within the inventive concept.

The subject device and method of use is sometimes referred to as the device, the invention, the mount, machine or other similar terms. These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A phone wrist mount comprised of a band and a plate;
The band is dimensioned to removably fit onto a human forearm or wrist;
The band includes a socket that is exposed on an exterior side of the band;
The plate has a first surface and a second surface joined by a perimeter edge;
The first surface of the plate is covered with an adherent;
The second surface of the plate includes a neck;
The neck is dimensioned to engage with the socket;
The neck engages into the socket forming a rotatable joint;
The plate rotates relative to band about the rotatable joint;
The rotatable joint is indexed to bias the plate relative to the band at a predetermined angle.

2. The phone wrist mount as in claim 1 further characterized in that the adherent is any of a plurality of micro suction cups, an adhesive or a supple layer.

3. The phone wrist mount as in claim 1 further characterized in that the rotatable joint is indexed to bias an orientation of a phone attached to the second surface of the plate at a portrait orientation or a landscape orientation.

4. The phone wrist mount as in claim 1 further characterized in that the strap is securable to a user's forearm or wrist with hook and look fasteners.

5. A phone wrist mount comprised of a band and a plate;
The band is dimensioned to removably fit onto a human forearm or wrist;
The band includes a socket that is exposed on an exterior side of the band;
The plate has a first surface and a second surface joined by a perimeter edge;
The first surface of the plate is covered with a plurality of micro suction cups;
The second surface of the plate includes a neck;
The neck is dimensioned to engage with the socket;
The neck engages into the socket forming a rotatable joint;
The plate rotates relative to band about the rotatable joint;
The rotatable joint is indexed to bias the plate relative to the band at a predetermined angle;
The rotatable joint is indexed to bias the orientation of a phone attached to the second surface of the plate at a portrait orientation or a landscape orientation;
The strap is securable to a user's forearm or wrist with hook and look fasteners.
